(19) United States
(12) Patent Application Publication
(10) Pub. No.: US 2025/0222998 A1
(43) Pub. Date: Jul. 10, 2025

(54) ELECTRIC MOBILITY VEHICLE

(71) Applicants: Hyundai Motor Company, Seoul (KR); Kia Corporation, Seoul (KR)

(72) Inventors: Sang Ah KO, Seoul (KR); Joon Ho LEE, Hwaseong-si (KR); Sun Woo LEE, Hwaseong-si (KR); Yun Ah JEONG, Hwaseong-si (KR); Han Bee JEONG, Hwaseong-si (KR)

(73) Assignees: Hyundai Motor Company, Seoul (KR); Kia Corporation, Seoul (KR)

(21) Appl. No.: 19/007,720

(22) Filed: Jan. 2, 2025

(30) Foreign Application Priority Data
Jan. 5, 2024 (KR) 10-2024-0002177

(51) Int. Cl. B62D 63/02; B60L 50/60

(52) U.S. Cl. CPC B62D 63/025; B60L 50/60

(57) ABSTRACT

A plurality of prefabricated mobiles may each autonomously travel, and a space optimized for the purpose of use may be provided by changing an assembled shape of the prefabricated mobile in accordance with various purposes of use so that versatility may be improved.

### CROSS-REFERENCE TO RELATED APPLICATION

The present application claims priority to Korean Patent Application No. 10-2024-0002177 filed on Jan. 5, 2024, the entire contents of which is incorporated herein for all purposes by this reference.

### BACKGROUND OF THE PRESENT DISCLOSURE

### Field of the Present Disclosure

The present disclosure relates to an electric mobility vehicle configured for autonomously traveling and providing various spaces in accordance with the purpose of use.

### Description of Related art

Recently, urban air mobility (UAM), purpose-built vehicles (PBV), and hubs (mobility transit hubs) have been in the limelight as future autonomous mobility vehicles, and various visions and advanced technology developments have been initiated in this regard.

The purpose-built vehicles (PBVs, purpose-built mobility) are electric vehicle-based ground transportation means that are moved by electric wheels that move freely in 360 degrees instead of the wheels of a vehicle. The PBVs are not only used as a means of transportation, but also to provide personalized services to passengers as they travel to their destination. The personalized design of the PBVs means that they can function as city shuttles, provide leisure spaces such as restaurants, cafes, and hotels, and may be transformed into various spaces such as hospitals, pharmacies, and other socially essential facilities. To the present end, an interior of a vehicle body may be customized by use of products modularized to suit the purpose thereof.

However, indoor spaces of the PBVs are designed, personalized, and diversified, and the modularization thereof is limited to the indoor spaces.

The versatility needs to be increased to meet the purpose of use of electric vehicles in the future, and technologies are required to be developed accordingly.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electric mobility vehicle configured for autonomously traveling and providing various spaces in accordance with the purpose of use.

According to one aspect, there is provided an electric mobility vehicle including: a plurality of prefabricated mobiles each including a body including a base and a panel extending upwards from the base, and a drive module mounted on the base and configured to be travelable, in which the bodies of the plurality of prefabricated mobiles are configured to be connected to one another, and the bodies of the prefabricated mobiles are connected to one another so that a space is defined inside or outside the panel of the body.

The panel of the body of the prefabricated mobile may be provided as a plurality of panels on the base, and the bodies of the different prefabricated mobiles may be connected through the panels.

The body of the prefabricated mobile may include two panels, and the panels may be connected in an orthogonal direction therebetween.

Upper and lower portions of the panel of the body may extend curvedly and be formed curvedly in a direction opposite in a direction in which the upper and lower portions of the panel intersect each other.

Four prefabricated mobiles may be provided to be connected to one another, and the space may be defined by the bodies of the prefabricated mobiles.

The space may be formed inward as the panels of the prefabricated mobiles assembled to one another in a direction in which surfaces thereof face one another in a state in which the panels of the two prefabricated mobiles are connected so that surfaces thereof face one another and the panels of the remaining two prefabricated mobiles are connected so that surfaces thereof face one another.

The prefabricated mobile may further include a roof and a floor attachable to or detachable from upper and lower portions of the panel, and upper and lower portions of the prefabricated mobiles assembled to one another may be connected by the roof and the floor to expand the space.

The roof and the floor may be divided into a plurality of roofs and floors and detachably connected to each other.

The prefabricated mobile may further include a wall portion detachably connected to the body, and at least one wall portion may be provided in the space formed inward by connecting the plurality of prefabricated mobiles.

A lateral portion of the panel of the prefabricated mobile may be connected to lateral portions of the panels of the different prefabricated mobiles to form a support structure while forming the space inwardly.

The prefabricated mobile may further include a roof and a floor attachable to or detachable from upper and lower portions of the panel, and the roof and the floor may be mounted on some of the prefabricated mobiles in an outward direction to form a space outward.

The prefabricated mobile may further include a detachable wall portion, and the space, which is formed outward, may be closed when the wall portion is mounted on the roof and the floor.

A power supplier may be provided in the space formed inward by the prefabricated mobile, and the power supplier may be electrically connected to the prefabricated mobile.

A drive module, which is configured to be travelable, may be further provided on the power supplier.

The plurality of prefabricated mobiles may be electrically connected when the plurality of prefabricated mobiles are connected to one another by the bodies, and the plurality of prefabricated mobiles may share power and a control signal.

According to the electric mobility vehicle with the above-mentioned structure, the plurality of prefabricated mobiles may each autonomously travel, and the space optimized for the purpose of use may be provided by changing the assembled shape of the prefabricated mobile in accordance with various purposes of use so that the versatility may be improved.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a prefabricated mobile of an electric mobility vehicle according to an exemplary embodiment of the present disclosure.

FIG. 2 is a view exemplarily illustrating an assembled shape according to the exemplary embodiment of the electric mobility vehicle according to an exemplary embodiment of the present disclosure.

FIG. 3 is a top plan view of the assembled shape according to the exemplary embodiment illustrated in FIG. 2.

FIG. 4 is a view exemplarily illustrating an example in which a roof and a floor are separated in the assembled shape according to the exemplary embodiment illustrated in FIG. 2.

FIG. 5 is a view exemplarily illustrating an assembled shape according to another exemplary embodiment of the electric mobility vehicle according to an exemplary embodiment of the present disclosure.

FIG. 6 is a top plan view of the assembled shape according to another exemplary embodiment illustrated in FIG. 5.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. The same or similar constituent elements are assigned with the same reference numerals regardless of reference numerals, and the repetitive description thereof will be omitted.

The suffixes “module”, “unit”, “part”, and “portion” used to describe constituent elements in the following description are used together or interchangeably to facilitate the description, but the suffixes themselves do not have distinguishable meanings or functions.

In the description of the embodiments included in the present specification, the specific descriptions of publicly known related technologies will be omitted when it is determined that the specific descriptions may obscure the subject matter of the embodiments included in the present specification. Furthermore, it should be interpreted that the accompanying drawings are provided only to allow those skilled in the art to easily understand the embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

Hereinafter, an electric mobility vehicle according to an exemplary embodiment of the present disclosure will be described with reference to the accompanying drawings.

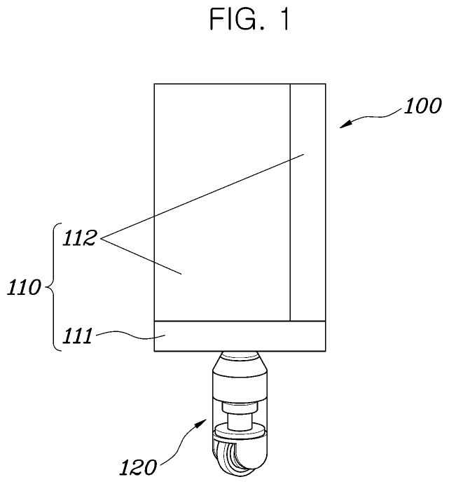

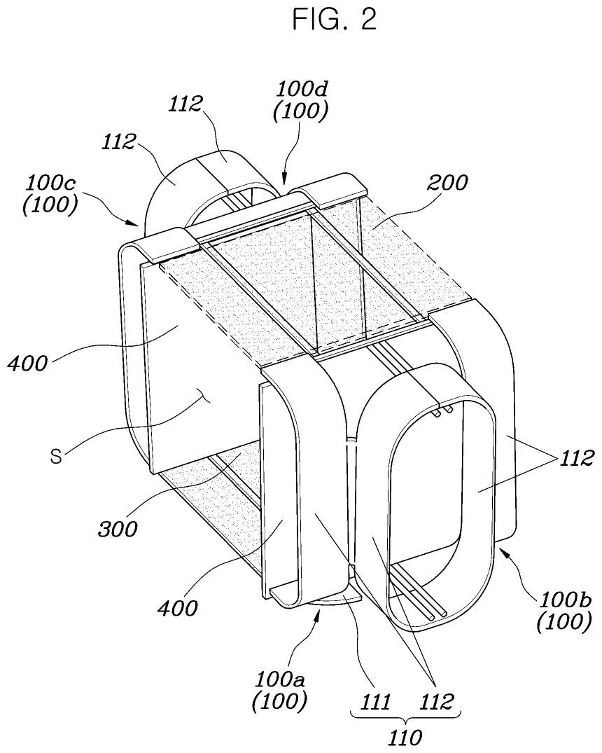

As illustrated in FIGS. 1 to 2, the electric mobility vehicle according to an exemplary embodiment of the present disclosure includes a plurality of prefabricated mobiles 100 each including a body 110 including a base 111 and a panel 112 extending upwards from the base 111, and a drive module 120 mounted on the base 111 and configured to be travelable.

The prefabricated mobile 100 is a future mobility vehicle such as a robotic space or a mobility pavilion.

The robotic space is a space concept of a mobility vehicle flexibly transformable to suit the purpose and situation by a software-based vehicle control system. The robotic technology may conveniently and safely transform the space by minimizing a user's physical effort and a required time. Furthermore, the robotic space is a concept which may provide various experiences in the mobility vehicle by variability of content and service through software, provide various spaces as a movement means, and expand to a new business platform by increasing the utilization of the space even at the time when the robotic space does not move.

The mobility pavilion is configured to regenerate an urban area in an infrastructure-deprived area by reusing and recycling end-of-life mobility vehicles. The mobility pavilion is a concept that serves as a physical hub for connecting various mobility vehicles in a metropolitan area and is configured to provide various experiences of the movement means by eliminating a boundary between the architecture and the mobility vehicle. That is, the mobility pavilion may also serve as an infrastructure in addition to the mobility vehicle in accordance with the user by a structure optimized for assembling, expansion, and modification by module designs. As described above, the mobility pavilion proposes a recycling concept recreated as a space by reusing old mobility vehicle modules with the fulfilled purpose of use and proposes environmentally-friendly, efficient future urban infrastructures configured for making spaces and vehicles in production lines for the mobility vehicles.

The prefabricated mobile 100 for implementing the robotic space or the mobility pavilion will be described.

The prefabricated mobile 100 of the present disclosure includes the body 110 and the drive module 120.

In the instant case, the body 110 includes the panel 112 configured to define an external wall by extending upwards from the base 111 configured to define a bottom surface. The specifications of the base 111 and the panel 112 of the body 110 may be determined depending on a target load in accordance with the purpose of use, and an overall length and a width of the body 110 may be determined in accordance with the purpose of use, providing a space that conforms to the purpose of use together with another prefabricated mobile 100.

The drive module 120 may have integrated traveling, steering, braking, and suspension functions and be configured to perform autonomous driving. The drive module 120 may be mounted on the base 111 of the body 110 and provide the mobility to the body 110 so that the drive module 120 may move the body 110 to a desired destination, or adjust the position of the body 110 to suit the purpose of use by adjusting a height by the suspension function. The drive module 120 may be controlled by a controller, and the operation of the drive module 120 may be controlled by communication between the controllers of the different prefabricated mobiles 100.

The prefabricated mobile 100 of the present disclosure is provided as a plurality of prefabricated mobiles 100, and the bodies 110 of the prefabricated mobiles 100 may be connected to one another. Therefore, a locking structure may be applied to the base 111 or the panel 112 of the body 110 of each of the prefabricated mobiles 100, and various ways, such as electromagnets and mechanical fitting, may be applied as the locking structure.

Therefore, when the bodies 110 of the prefabricated mobiles are connected to one another, spaces may be formed inside or outside the panels 112 of the bodies 110. That is, a position of the space, a size of the space, and the like are changed depending on assembling directions and assembled shapes of the prefabricated mobiles so that the space suitable for the purpose of use may be provided.

The present disclosure will be described specifically. The body 110 of the prefabricated mobile 100 may include the plurality of panels 112 provided on the base 111, and the bodies 110 of the different prefabricated mobiles may be connected through the panels 112.

As may be seen in FIG. 1 and FIG. 2, the body 110 includes the base 111 and the panel 112, and the panel 112 is provided as a plurality of panels 112 provided on the base 111 so that a space S may be formed when the body 110 is connected to the body 110 of another prefabricated mobile 100.

The panel 112 may be configured to be attachable to or detachable from the body 110, and an overall length and a width of the panel 112 are designed to suit the purpose of use, improving the versatility.

Furthermore, the prefabricated mobile 100 may be assembled to another prefabricated mobile 100. To the present end, the prefabricated mobiles 100 may be configured so that the bodies 110 are connected to one another. Therefore, a locking structure may be applied to the panel 112 that forms the body 110, and various ways, such as electromagnets and mechanical fitting, may be applied as the locking structure.

According to an exemplary embodiment of the present disclosure described above, various spaces may be defined by changing the number of prefabricated mobiles 100, the shape of the body 110 of the prefabricated mobile 100, and the connection positions of the different prefabricated mobiles 100 by use of the plurality of prefabricated mobiles 100 so that the spaces optimized for various purposes of use may be provided.

Furthermore, the plurality of prefabricated mobiles 100 are electrically connected to one another through the bodies 110 so that the plurality of prefabricated mobiles 100 may share electric power and control signals.

That is, when the plurality of prefabricated mobiles 100 are connected through the bodies 110, the plurality of prefabricated mobiles 100 may be fixed by the locking structures and share electric power and control signals through electrical connection or communication.

Therefore, the prefabricated mobiles 100 connected to one another may operate as one module and be separated from or assembled to one another through communication and control therebetween, providing the space suitable for various purposes of use.

In an exemplary embodiment of the present disclosure, the body 110 of the prefabricated mobile 100 may include two panels 112, and the panels 112 may be connected in an orthogonal direction therebetween.

As may be seen in FIG. 1 and FIG. 2, the two panels 112 are orthogonally disposed on one base 111 of the prefabricated mobile 100 so that the space S may be defined between the panels 112. In an exemplary embodiment of the present disclosure, the body 110 of the prefabricated mobile 100 may include three panels 112 or only a single panel 112. However, the present disclosure is not limited thereto.

In an exemplary embodiment of the present disclosure, the two panels 112 are orthogonally disposed to provide an efficient space by the connection structure of each of the prefabricated mobiles 100. An exemplary embodiment in which the body 110 of the prefabricated mobile 100 includes the two panels 112 will be described.

Meanwhile, upper and lower portions of the panel 112 of the body 110 curvedly extend, and may be formed curvedly in a direction opposite in a direction in which the panels 112 intersect each other.

As may be seen in FIG. 2, the upper and lower portions of the panel 112 of the body 110 of the prefabricated mobile 100 may be formed curvedly so that the body 110 may be easily connected to the body 110 of another prefabricated mobile 100.

Because the upper and lower portions of the panel 112 extend curvedly, a space may be defined above and below the curved portions, and the spatial utilization may be improved so that the versatility may be increased in accordance with the purpose of use.

Furthermore, because the upper and lower portions of the panel 112 of the prefabricated mobile 100 extend curvedly in the direction opposite to the direction in which the upper and lower portions of the panel 112 intersect each other, the curved portions do not intersect each other, and the curved portions have shapes extending to external peripheries, ensuring the connectivity with the panel 112 of another prefabricated mobile 100.

According to the exemplary embodiment of the present disclosure, four prefabricated mobiles 100 may be configured to be connected to one another so that the space S may be defined by the bodies 110 of the prefabricated mobiles 100.

That is, according to an exemplary embodiment of the present disclosure, the body 110 of the prefabricated mobile 100 includes the two panels 112 orthogonally disposed on the base 111 so that the space S with a quadrangular shape may be ensured when the four prefabricated mobiles 100 are connected. Of course, various spaces S may be defined by increasing or decreasing the number of prefabricated mobiles 100. The prefabricated mobiles 100 according to an exemplary embodiment of the present disclosure may define the quadrangular space S, simplifying the structure and facilitating the process of ensuring and changing the space S.

An exemplary embodiment in which the prefabricated mobiles 100 of the present disclosure include a first prefabricated mobile 100a, a second prefabricated mobile 100b, a third prefabricated mobile 100c, and a fourth prefabricated mobile 100d will be described.

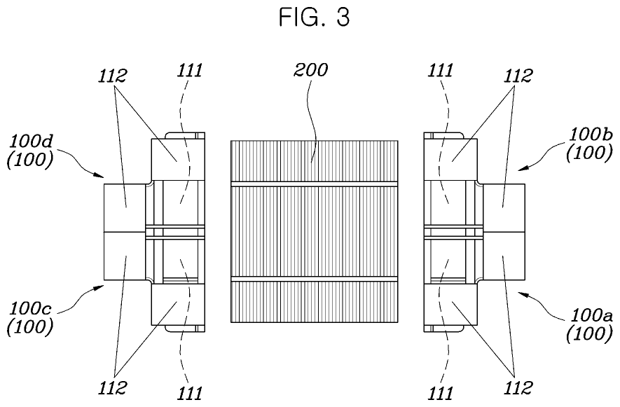

As illustrated in FIG. 2 and FIG. 3, in the exemplary embodiment of the present disclosure, the space S may be defined inside the panels 112 of the bodies 110 when the upper and lower portions of the panels 112 of the two prefabricated mobiles 100 are connected to one another, the upper and lower portions of the panels 112 of the remaining two prefabricated mobiles 100, and then the upper and lower portions of another panel 112 are connected to the prefabricated mobiles 100 assembled to one another.

With reference to FIG. 2, the first prefabricated mobile 100a and the second prefabricated mobile 100b are modularized as the panels 112 are connected to one another in a direction in which surfaces thereof face one another, and the third prefabricated mobile 100c and the fourth prefabricated mobile 100d are modularized as the panels 112 are connected to one another in a direction in which surfaces thereof face one another.

Because the upper and lower portions of the panels 112 of the first prefabricated mobile 100a and the second prefabricated mobile 100b are formed curvedly, the space may be easily ensured when the upper and lower portions are connected. Likewise, the upper and lower portions of the panels 112 of the third prefabricated mobile 100c and the fourth prefabricated mobile 100d may be connected to one another.

In the instant case, the panels 112 of the first prefabricated mobile 100a and the second prefabricated mobile 100b are connected to the panels 112 of the third prefabricated mobile 100c and the fourth prefabricated mobile 100d in a direction in which surfaces thereof face one another so that the space S may be defined inside the prefabricated mobiles 100.

Furthermore, the prefabricated mobile 100 may further include a roof 200 and a floor 300 attachable to or detachable from the upper and lower portions of the panel 112.

Overall lengths and widths of the roof 200 and the floor 300 may be designed to suit the purpose of use, and the upper and lower portions of the prefabricated mobiles 100 are connected to one another by the roof 200 and the floor 300 so that the space S disposed inside the prefabricated mobiles 100 may be expanded.

That is, the roof 200 and the floor 300 are connected to the panels 112 of the first prefabricated mobile 100a and the second prefabricated mobile 100b and connected to the panels 112 of the third prefabricated mobile 100c and the fourth prefabricated mobile 100d so that the prefabricated mobiles 100 are connected by the roof 200 and the floor 300. Furthermore, the space S between the prefabricated mobiles 100 may be determined depending on sizes of the roof 200 and the floor 300 so that the space S optimized for the purpose of use may be provided in accordance with the sizes of the roof 200 and the floor 300.

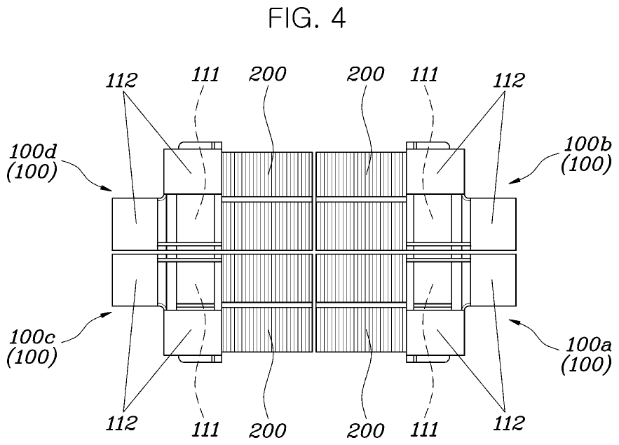

Furthermore, as illustrated in FIG. 4, the roof 200 and the floor 300 may be divided into a plurality of roofs and floors, and the plurality of roofs and floors may be detachably connected to one another so that the size of the internal space S of the prefabricated mobile 100 may be more efficiently adjusted.

For example, the roof 200 and the floor 300 may be divided into four roofs and four floors when four prefabricated mobiles 100 are provided, and the utilization of the space S may be improved by selectively disposing the roofs 200 and the floors 300 in accordance with the purpose of use.

Meanwhile, as may be seen in FIG. 2, the prefabricated mobile 100 may further include a wall portion 400 detachably connected to the body 110.

That is, the wall portion 400 may be disposed in the internal space S defined by connecting the plurality of prefabricated mobiles 100 and serve as an internal wall. The wall portion 400 may be provided as a plurality of wall portions 400 that support the internal space S defined by the prefabricated mobiles 100 or are used as various shapes in accordance with the purpose of use.

For example, the wall portions 400 are connected to the panels 112 of the first prefabricated mobile 100a and the second prefabricated mobile 100b and connected to the panels 112 of the third prefabricated mobile 100c and the fourth prefabricated mobile 100d so that the wall portions 400 may be designed as internal walls of the internal space S defined by the prefabricated mobiles 100.

The wall portions 400 may be used to provide various convenience functions in the space S defined by the prefabricated mobile 100 in accordance with the purpose of use, and the convenience of the spatial utilization may be provided by adding the function in accordance with the purpose of use.

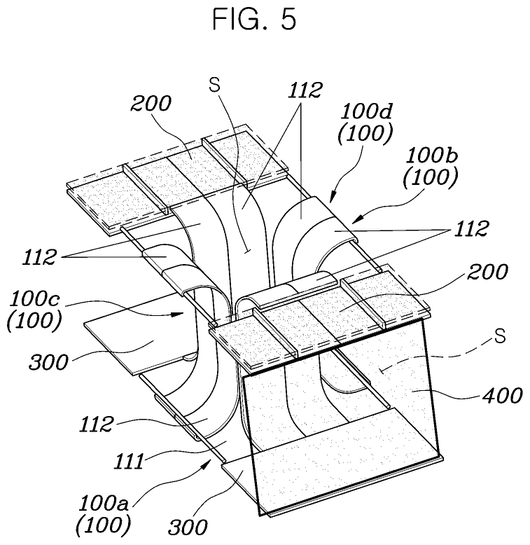

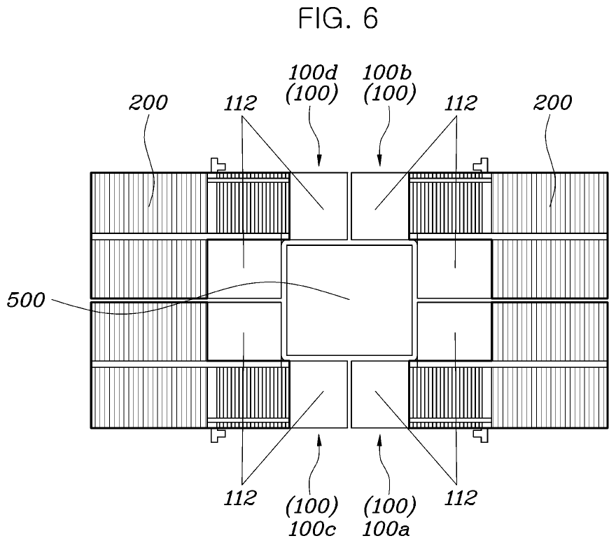

Meanwhile, as illustrated in FIG. 5 and FIG. 6, in another exemplary embodiment of the present disclosure, a lateral portion of the panel 112 of the prefabricated mobile 100 is connected to lateral portions of the panels 112 of the different prefabricated mobiles 100, forming a support structure while forming the internal space S inwardly.

With reference to FIG. 5, edge portions of the panel 112 of the prefabricated mobile 100 are connected to define one surface so that the space S is formed inwardly.

That is, the panel 112 of the first prefabricated mobile 100a is connected to the second prefabricated mobile 100b and the third prefabricated mobile 100c, and the remaining panel 112 of the fourth prefabricated mobile 100d, which is not connected to the first prefabricated mobile 100a, is connected to the second prefabricated mobile 100b and the third prefabricated mobile 100c so that the panel 112 of the prefabricated mobile 100 includes a column shape and forms the support structure.

Furthermore, the space S is formed inward by the prefabricated mobile 100 so that the robust support structure may be configured, and the internal space S may be used.

For example, a power supplier 500 may be further provided in the internal space S defined by the prefabricated mobile 100. The power supplier 500 may be a battery or a fuel cell. Because the power supplier 500 is provided in the internal space S defined by the prefabricated mobile 100, the power supplier 500 may be protected from the outside thereof and easily electrically connected to the prefabricated mobile 100.

Furthermore, the drive module 120, which is configured to be travelable, may be further provided on the power supplier 500 so that a user, together with the prefabricated mobile 100, may move to a desired position. A means for fixing the power supplier 500 to the prefabricated mobile 100 is not required, and the drive module 120 provided on the power supplier 500 may be synchronized with the drive module 120 provided on the prefabricated mobile 100 so that the power supplier 500 may move stably.

Meanwhile, the prefabricated mobiles 100 may each further include the roof 200 and the floor 300 attachable to or detachable from the upper and lower portions of the panel 112. Therefore, the roof 200 and the floor 300 may be mounted outward on some of the prefabricated mobiles 100 so that the space S may be defined outward.

The overall lengths and widths of the roof 200 and the floor 300 may be designed to suit the purpose of use. Because the space S is formed outward by the roof 200 and the floor 300, various purposes of use may be achieved by use of the corresponding space S.

FIG. 5 illustrates that the roof 200 and the floor 300 are provided to connect the first prefabricated mobile 100a and the second prefabricated mobile 100b, and the roof 200 and the floor 300 are provided to connect the third prefabricated mobile 100c and the fourth prefabricated mobile 100d. However, the space S may be formed outward by selectively applying the roof 200 and the floor 300 to the prefabricated mobile 100 in accordance with the purpose of use.

In the instant case, the prefabricated mobile 100 may further include the detachable wall portion 400, and the space S, which is formed outward, may be closed when the wall portion 400 is mounted on the roof 200 and the floor 300.

That is, the wall portion 400 may be disposed to seal the space S formed outward by the roof 200 and the floor 300 so that the wall portion 400 may serve as an external wall. The plurality of wall portions 400 may be provided on the roof 200 and the floor 300 and block the space S, which is formed outward, from the outside thereof.

The wall portion 400 may also be detachably connected to the panel 112 of the prefabricated mobile 100 and define a new space S. The wall portion 400 may not only ensure the utilization of the space S, which is formed outward between the roof 200 and the floor 300, but also ensure the utilization of the space S of the prefabricated mobile 100.

Furthermore, the wall portion 400 may form the support structure for the roof 200 and the floor 300 and ensure the stability of the space S formed outward by the roof 200 and the floor 300.

According to the electric mobility vehicle with the above-mentioned structure, the plurality of prefabricated mobiles 100 may autonomously travel, and the space S optimized for the purpose of use by changing the assembled shape of the prefabricated mobile 100 in accordance with various purposes of use may be provided so that the versatility may be improved.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electric mobility vehicle comprising:
a plurality of prefabricated mobiles each including a body including a base and a panel extending upwards from the base, and a drive module mounted on the base and configured to be travelable,
wherein the bodies of the plurality of prefabricated mobiles are configured to be connected to one another, and the bodies of the prefabricated mobiles are connected to one another so that a space is defined inside or outside the panel of the body.

2. The electric mobility vehicle of claim 1,
wherein the plurality of panels are provided on the base, and the bodies of the different prefabricated mobiles are connected through the plurality of panels.

3. The electric mobility vehicle of claim 1, wherein the body of the prefabricated mobiles includes first and second panels, and the first and second panels are connected in an orthogonal direction therebetween.

4. The electric mobility vehicle of claim 3, wherein upper and lower portions of the panel of the body extend curvedly and are formed curvedly in a direction opposite in a direction in which the upper and lower portions of the panel intersect each other.

5. The electric mobility vehicle of claim 3, wherein four prefabricated mobiles are provided to be connected to one another, and the space is defined by bodies of the four prefabricated mobiles.

6. The electric mobility vehicle of claim 5, wherein the space is formed inward as the panels of the four prefabricated mobiles assembled to one another in a direction in which surfaces thereof face one another in a state in which the panels of the two prefabricated mobiles among the four prefabricated mobiles are connected so that surfaces of the two prefabricated mobiles face one another and the panels of the remaining two prefabricated mobiles among the four prefabricated mobiles are connected so that surfaces of the remaining two prefabricated mobiles face one another.

7. The electric mobility vehicle of claim 6, wherein the four prefabricated mobiles further includes a roof and a floor attachable to or detachable from upper and lower portions of the panel,
wherein upper and lower portions of the four prefabricated mobiles assembled to one another are connected by the roof and the floor to expand the space.

8. The electric mobility vehicle of claim 7, wherein the roof and the floor are divided into a plurality of roofs and floors and detachably connected to each other.

9. The electric mobility vehicle of claim 6, further including a wall portion detachably connected to the body, and at least one wall portion is provided in the space formed inward by connecting the four prefabricated mobiles.

10. The electric mobility vehicle of claim 5, wherein a lateral portion of the panel of the prefabricated mobile is connected to lateral portions of panels of different prefabricated mobiles to constitute a support structure while forming the space inward.

11. The electric mobility vehicle of claim 10, wherein the prefabricated mobile further includes a roof and a floor attachable to or detachable from upper and lower portions of the panel,
wherein the roof and the floor are mounted on a predetermined number of the prefabricated mobiles in an outward direction to form a space outward.

12. The electric mobility vehicle of claim 11, further including a detachable wall portion,
wherein the space, which is formed outward, is closed in response that the wall portion is mounted on the roof and the floor.

13. The electric mobility vehicle of claim 10, wherein a power supplier is provided in the space formed inward by the prefabricated mobile, and the power supplier is electrically connected to the prefabricated mobiles.

14. The electric mobility vehicle of claim 13, wherein a drive module, which is configured to be travelable, is further provided on the power supplier.

15. The electric mobility vehicle of claim 1, wherein the plurality of prefabricated mobiles are electrically connected in response that the plurality of prefabricated mobiles are connected to one another by the bodies, and the plurality of prefabricated mobiles share power and a control signal.
